(19) United States
(12) Patent Application Publication
(10) Pub. No.: US 2025/0059712 A1
(43) Pub. Date: Feb. 20, 2025

(54) STRENGTH ENHANCEMENT AGENT FOR PAPER AND PAPERBOARD

(71) Applicant: Stora Enso OYJ, Helsinki (FI)

(72) Inventors: Kaj Backfolk, Lappeenranta (FI); Isto Heiskanen, Imatra (FI); Anders Moberg, Hammarö (SE); Katja Lyytikäinen, Imatra (FI); Cecilia Land Hensdal, Forshaga (SE); Anna Kauppi, Lappeenranta (FI)

(73) Assignee: Stora Enso OYJ, Helsinki (FI)

(21) Appl. No.: 18/717,641

(22) PCT Filed: Dec. 12, 2022
(86) PCT No.: PCT/IB2022/062050

§ 371 Date: Jun. 7, 2024

(30) Foreign Application Priority Data
Dec. 15, 2021 (SE) 2151535-8

(51) Int. Cl. D21H 21/18; D21D 1/20; D21H 11/02; D21H 11/18; D21H 15/06

(52) U.S. Cl. CPC D21H 21/18; D21D 1/20; D21H 11/02; D21H 11/18; D21H 15/06

(57) ABSTRACT

The present invention relates to a strength enhancement agent for paper and paperboard, said strength enhancement agent comprising a fines-depleted highly refined cellulose pulp (FD-HIRC), wherein said FD-HIRC has a Schopper-Riegler (SR) number in the range of 60-100 as determined by standard ISO 5267-1, and wherein said FD-HRC has an amount of long (>0.2 mm) fibers of at least 8 million fibers per gram (based on dry weight), and wherein said FD-HRC has a Fines A value below 46, wherein the Fines A value is determined using an FS5 optical fiber analyzer. The present invention relates to a method for manufacturing said strength enhancement agent.

### TECHNICAL FIELD

The present disclosure relates to strength enhancement agents for improving paper or paperboard strength properties, especially for improving Z-strength and/or tensile strength. The present disclosure further relates to the manufacture of such strength enhancement agents and to paper or paperboard comprising such strength enhancement agents.

### BACKGROUND

Paperboard comprises a plurality of layers, also known as plies, of pulp and optional additives. The layers are selected and arranged to achieve the desired properties of the paperboard as such. An essential property of the paperboard is the bending stiffness. The bending stiffness in paperboard is usually built up by having outer plies with high tensile stiffness and one or several bulky plies in between, so that the outer plies are placed at a desired distance from each other. The bulky ply/plies is/are often a middle layer/middle layers.

The middle layer in paperboard may comprise a mechanical pulp, such as thermomechanical pulp (TMP) or chemi-thermomechanical pulp (CTMP). TMP and CTMP generally have a high bulk, thereby enabling constructing paperboard with the desired high stiffness at low grammage, compared to for example chemical pulps.

The middle layer may also comprise recycled pulp or fibers, such as broke or pre or post consumer reject or recycled material. These materials may often require strength additives in order to provide desired mechanical properties

In the CTMP process, wood chips are impregnated with a lignin softening chemical prior to pressurized refining. This results in softening of lignin and the fiber rupture during refining will therefore be concentrated to the lignin rich middle lamella. This results in stiff fibers and a lower amount of fines and shives at a certain energy input compared to TMP. A high concentration of long fibers is important for all products where high bulk is desired. Therefore, CTMP is more advantageous than TMP in paperboard.

The strength of paper is measured in three dimensions: the grain direction, also known as the X-direction; the cross-grain direction, also known as Y-direction; and the direction perpendicular to the paper surface plane, also known as the Z-direction. The force needed to delaminate a sample of a paper is recorded as its internal bond strength, or Z-directional tensile strength. A high Z-strength in the middle layer of paperboard is desired in order to avoid delamination of the middle layer and hence delamination of the paperboard as such. Such a Z-strength must however be achieved without deteriorating the bending stiffness, that is without having to increase the paper web density.

Z-strength and density of a paperboard layer is usually optimized by altering the raw materials, by choosing different operation conditions in stock preparation and on the board machine and by addition of paper chemicals. Like many other strength properties, strength in Z-direction increases with increased density and the effect comes from increase of bonded area between the fibers. The relationship between density and out-of-plane strength may vary depending on pulp type and densification method. Refining increases strength more than wet pressing. The main purpose of refining is to improve the bonding properties of the fibers. Changes that improve fiber-to-fiber bonding are internal and external fibrillation together with fines creation. All three changes result in an increase of the water-holding capacity of the pulp, its density and strength properties such as tensile strength and stiffness, burst and compression strength, and also strength in Z-direction.

While CTMP provides a high bulk, the Z-strength of CTMP is comparatively low.

It is not only paperboard which requires high delamination resistance and bending stiffness. These properties are important in for example printing, in converting and in end-use situations. This means that producing paper and board with high strength in Z-direction is very important for many paper products.

Strength in fiber and paperboard products can be increased by enhancing fiber-fiber contact, such as by surface fibrillation, by using modified fibers, or by using natural or synthetic strength enhancing chemicals such as polysaccharides.

One of the recent development trends is to use microfibrillated cellulose, or nanocellulose, as a strength enhancing agent. While nanocellulose is very useful as a strength enhancement agent, the addition of nanocellulose may also lead to unwanted side-effects, such as reduced dewatering speed and/or increased chemical consumption as the nanocellulose efficiently binds and retains water and dissolved process chemicals.

Another problem is that the strength enhancing agents may increase the density and hence affect the bending stiffness of the paper or paperboard. Another challenge is that many strength enhancing agents are difficult to retain or fix to web especially when a higher content of recycled fiber is used.

Thus, there remains a need for improved solutions to improve the tensile strength and Z-strength strength of paper or paperboard, while avoiding the disadvantages of the prior art techniques.

### DESCRIPTION OF THE INVENTION

A specific object of the invention is to provide a new type of strength enhancement agent that gives paper or paperboard better strength properties, especially a better tensile strength and a better Z-strength.

A further object of the invention is to provide a new cellulose based strength enhancement agent that gives paper or paperboard better strength properties, especially a better tensile strength and a better Z-strength.

A further object of the invention is to provide a cellulose based strength enhancement agent, which can reduce the problems of reduced dewatering speed and/or increased chemical consumption caused by previous cellulose-based strength enhancement agents.

The above-mentioned objects, as well as other objects as will be realized by the skilled person in the light of the present disclosure, are achieved by the various aspects of the present disclosure.

The present invention is based on the realization that a relatively small portion of fines, including fine cellulosic particles and dissolved and colloidal substances, in highly refined cellulose pulp suspensions is responsible to a high degree for the high water retention and/or high drainage resistance of suspensions and formed webs containing the highly refined cellulose pulp. The fines also consume a high proportion of chemical additives used in pulp and paper production.

According to a first aspect illustrated herein, there is provided a strength enhancement agent for paper and paperboard, said strength enhancement agent comprising

a fines-depleted highly refined cellulose pulp (FD-HRC),

wherein said FD-HRC has a Schopper-Riegler (SR) number in the range of 60-100 as determined by standard ISO 5267-1.

In some embodiments, the FD-HRC has an amount of long (>0.2 mm) fibers of at least 8 million fibers per gram (based on dry weight), and

a Fines A value below 46%, wherein the Fines A value is determined using an FS5 optical fiber analyzer.

In some embodiments, the term highly refined cellulose pulp as used herein refers to a cellulose pulp which has been subjected to considerable refining, but not to the extent that all of the cellulose pulp will pass through a 200 mesh screen (equivalent hole diameter 76 μm) of a conventional laboratory fractionation device (SCAN-CM 66:05). Preferably no more than 60% of the highly refined cellulose pulp will pass through a 200 mesh screen of a conventional laboratory fractionation device according to SCAN-CM 66:05. More preferably no more than 50% of the highly refined cellulose pulp will pass through a 200 mesh screen of a conventional laboratory fractionation device according to SCAN-CM 66:05. In some embodiments, 5-60% and more preferably 10-50 wt % of the highly refined cellulose pulp will pass through a 200 mesh screen of a conventional laboratory fractionation device according to SCAN-CM 66:05. Thus, the highly refined cellulose pulp will comprise a mixture of finer particles and coarser particles. The size distribution of the particles in the highly refined cellulose pulp may depend on the starting material and the refining processes used.

The term fines as used herein generally refers to fine cellulosic particles, which pass through a 200 mesh screen (equivalent hole diameter 76 μm) of a conventional laboratory fractionation device (SCAN-CM 66:05). There are two major types of fiber fines, namely primary and secondary fines. Primary fines are generated during pulping and bleaching, where they are removed from the cell wall matrix by chemical and mechanical treatment. As a consequence of their origin (i.e., compound middle lamella, ray cells, parenchyma cells), primary fines exhibit a flake-like structure with only minor shares of fibrillar material. In contrast, secondary fines are generated during the refining of pulp. Both primary and secondary fines have a negative influence on dewatering in the forming section of a paper machine. The fines may also comprise dissolved and colloidal substances. The dissolved substances typically consist of ions and molecules having dimensions less than 0.1 μm, e.g. soluble polyelectrolytes such as hemicelluloses, pectins, and lignin fragments. The colloidal substances consist of dispersed particles about 0.1 to 1 μm, e.g. wood pitch, latex (from coated broke), and microfines. Because of their large specific surface area in comparison to pulp fibers, and their chemical composition and anionic charge, fines also consume a high proportion of chemical additives used in pulp and paper production.

The term “fines-depleted” as used herein denotes that at least some of the fines, including fine cellulosic particles and/or dissolved and colloidal substances, in the highly refined cellulose pulp have been removed. The removal changes the particle size distribution such that the FD-HRC has a lower portion of fine cellulosic particles and/or dissolved and colloidal substances than the HRC. The particle size distribution of the removed fines may depend on the composition of the HRC and the method used for removal. For example the fines removed from a very highly refined cellulose pulp, such as a microfibrillated cellulose (MFC) may comprise mainly very fine fines and dissolved and colloidal substances, whereas the fines removed from a less highly refined cellulose pulp may comprise a larger portion of fiber fines, such as primary and secondary fines.

As the starting material is a highly refined cellulose pulp, the removed fines may typically be comprised mainly of fibrils, fibril agglomerates, and or fibril bundles generated during the refining of the pulp.

The composition of fines in the HRC and FD-HRC of the present disclosure may advantageously be represented by the parameters Fines A and Fines B, as measured using the FS5 optical fiber analyzer (Valmet). The FS5 optical fiber analyzer typically does not register dissolved and colloidal substances.

The term “Fines A” as used herein refers to flake-like fines with a size under 0.2 mm (length<0.2 mm and width<0.2 mm). The projection area of the flake-like fines divided by the total fiber projection area*100% 32 Fines A.

The term “Fines B” as used herein refers to lamella-or fibril like long fines having a width of less than 5 μm and a length over 0.2 mm. The length of these objects divided by the length of all objects with length>0.2 mm*100%=Fines B.

The inventive strength enhancement agent having both a high SR value, a high amount of fibers having a length>0.2 mm, and a Fines A value below 46%, has been found to be very efficient as a strength enhancing agent when mixed in CTMP sheets, and may prove a sustainable alternative as source reduction agent for paper and paperboard production.

The fines removed are also expected to have very poor wire retention, especially in fast board/paper machines. The poor wire retention will lead to fines accumulation in the white waters, causing poor dewatering, foaming, formation of deposits into the systems, and microbiological problems reducing the overall efficiency of the board/paper production.

The strength enhancement agent preferably comprises at least 50 wt % of a fines-depleted highly refined cellulose pulp (FD-HRC). The strength enhancement agent may be comprised solely of the FD-HRC or of a combination of the FD-HRC and one or more other components. In some embodiments, the strength enhancement agent comprises at least 70 wt %, preferably at least 90 wt %, of the FD-HRC. In some embodiments, the strength enhancement agent consists of the FD-HRC. In some embodiments, the strength enhancement agent comprises in the range of 50-99 wt %, preferably in the range of 70-99 wt %, more preferably in the range of 80-99% by dry weight, and more preferably in the range of 90-99 wt % of FD-HRC, based on the total dry weight of the strength enhancement agent. The other components of the strength enhancement agent may for example include conventional (i.e. non-fines depleted) HRC or less refined cellulose pulp. The strength enhancement agent may further comprise additives such as native starch or starch derivatives, cellulose derivatives such as sodium carboxymethyl cellulose, fillers, dispersing agents, retention and/or drainage additives, deflocculating additives, dry strength additives, softeners, cross-linking aids, sizing chemicals, dyes and colorants, wet strength resins, fixatives, de-foaming aids, microbe and slime control aids, or mixtures thereof.

The strength enhancement agent preferably comprises no more than 30 wt % of additives in total, based on the total dry weight of the strength enhancement agent. More preferably the strength enhancement agent comprises no more than 20 wt % or 10 wt % of additives in total, based on the total dry weight of the strength enhancement agent.

When used in a pulp suspension, the inventive strength enhancement agent may also be combined with one or more additional strength enhancement agents. The additional strength enhancement agents may for example include polysaccharides. In some embodiments the additional strength enhancement agent is starch. In some embodiments, the inventive strength enhancement agent is the main strength enhancement agent based on dry weight. In some embodiments, the starch is the main strength enhancement agent based on dry weight. The inventive strength enhancement agent may for example constitute 1-50 wt % of the total weight of strength enhancement agents in the pulp suspension.

The FD-HRC is a highly refined cellulose pulp from which some of the fines have been removed by fractionation in order to obtain a highly refined cellulose pulp depleted in fines. Thus, the FD-HRC is based on a refined cellulose fiber composition. Refining, or beating, of cellulose pulps refers to mechanical treatment and modification of the cellulose fibers in order to provide them with desired properties. Refining, or beating, of cellulose pulps also leads to the formation of fines, including fine cellulosic particles and dissolved and colloidal substances, in the highly refined cellulose pulp.

Subsequent to the refining, the highly refined cellulose pulp has been subjected to fractionation to remove some of the fines to obtain a fines-depleted highly refined cellulose pulp (FD-HRC). In some embodiments, 0.2-4 wt %, preferably by 1-3 wt %, and more preferably by 1.5-2.5 wt %, of the total amount of highly refined cellulose pulp has been removed by the fractionation in order to obtain the FD-HRC.

The term highly refined cellulose pulp as used herein refers to a cellulose pulp having a Schopper-Riegler (SR) number in the range of 60-100 determined by standard ISO 5267-1. In some embodiments, the FD-HRC has a Schopper-Riegler (SR) number in the range of 85-98, preferably in the range of 90-97, as determined by standard ISO 5267-1.

In some embodiments, the FD-HRC comprises or consists of a microfibrillated cellulose (MFC) which has been fractionated to remove a portion of the finest cellulosic particles and/or dissolved and colloidal substances. The removal changes the particle size distribution such that the fractionated MFC has a lower portion of the finest cellulosic particles and/or dissolved and colloidal substances than the unfractionated MFC.

Microfibrillated cellulose (MFC) shall in the context of the patent application be understood to mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

In some embodiments, the FD-HRC is obtained from a chemical pulp, preferably a kraft pulp. The kraft pulp may be a bleached or unbleached kraft pulp, preferably a bleached kraft pulp. The FD-HRC can be produced from different raw materials, for example softwood pulp or hardwood pulp, or a mixture thereof. In preferred embodiments, the FD-HRC is obtained from a softwood pulp. In some embodiments, the FD-HRC is substantially free from lignin, preferably the FD-HRC has a lignin content below 10% by weight, based on the total dry weight of the FD-HRC. In some embodiments, the FD-HRC has a hemicellulose content in the range of 10-30% by weight, based on the total dry weight of the pulp FD-HRC.

The FD-HRC preferably has a relatively high amount of long fibers, i.e. of fibers having a length >0.2 mm. In some embodiments, the FD-HRC has an amount of long (>0.2 mm) fibers of at least 8 million fibers per gram (based on dry weight). In some embodiments, the FD-HRC has an amount of long (>0.2 mm) fibers of at least 10 million fibers per gram (based on dry weight), preferably at least 12 million fibers per gram (based on dry weight), and more preferably at least 14 million fibers per gram (based on dry weight). Unless otherwise stated, the amount of fibers having a length>0.2 mm is determined using the Fiber Tester Plus instrument (L&W/ABB). A known sample weight of 0.100 g is used for each sample and the amount of fibers having a length>0.2 mm (million fibers per gram) is calculated using the following formula: Million fibers per gram=(No. fibers in sample)/(Sample weight)/1 000 000=(Property ID 3141)/property ID 3136)/1 000 000.

In some embodiments, the FD-HRC has a fiber length Lc(n) FS5 ISO in the range of 0.25-0.7 mm, preferably in the range of 0.3-0.6 mm and more preferably in the range of 0.4-0.6 mm. The fiber length Lc(n) FS5 ISO can be determined using an FS5 optical fiber analyzer (Valmet).

The FD-HRC has been subjected to fractionation to remove some of the fines. Due to the fractionation, the FD-HRC preferably has a relatively low Fines A value, particularly in relation to the Fines B value, as determined using an FS5 optical fiber analyzer. In some embodiments, the FD-HRC has a Fines A value at least 1 percentage point lower than the Fines B value. In some embodiments, the FD-HRC has a Fines A value at least 1.5 percentage point(s) lower, preferably at least 2 percentage point(s) lower and more preferably in the range of 2-15 percentage point(s) lower, than the Fines B value, wherein the Fines A value and Fines B value are determined using an FS5 optical fiber analyzer. The relation between the amount of Fines A and Fines B has been found to be important to both improve the dewatering properties and the strength properties. The amount of Fines B should be more than the amount of Fines A in order to achieve the desired properties.

In some embodiments, the FD-HRC has a Fines A value below 45%, preferably below 43%, and more preferably below 40%. It may be preferred that the Fines A value is between 5-45%, preferably between 10-43% and even more preferred between 20-40%. It is preferred not to remove all Fines A material.

The inventive strength enhancement agent having both a high SR value, a high amount of fibers having a length>0.2 mm, and a Fines A value below 46%, has been found to be very efficient as a strength enhancing agent when mixed in pulp for paperboard, e.g. CTMP, and may prove a sustainable alternative as source reduction agent for paper and paperboard production.

As mentioned, the strength enhancement agent may be comprised of a combination of the FD-HRC and one or more other components.

In some embodiments, the strength enhancement agent may further comprise 0.01-10 wt % of a dispersing agent. The dispersing agent may for example be selected from the group consisting of anionic, nonionic or amphoteric polysaccharides (such as water soluble starch, CMC or cellulose derivatives), proteins, alginates, hemicelluloses and derivatives thereof, polyacrylic acids, acrylate copolymers, sodium salts of acrylic acids, polyacrylic acids, polyacrylamides, maleic acid, polymaleic acids, sodium malonate, sodium succinate, sodium malate, sodium glutamate, polyphosphates, sodium hexametaphosphate (SHMP), polyvinyl alcohol, polyvinyl acetate, PVOH/Ac, and sodium n-silicate, or combinations thereof.

The present invention further relates to a method for manufacturing a strength enhancement agent according to the first aspect.

Thus, according to a second aspect illustrated herein, there is provided a method for manufacturing a strength enhancement agent, said method comprising:

a) providing a highly refined cellulose pulp (HRC) suspension comprising HRC, wherein said HRC has a Schopper-Riegler (SR) number in the range of 60-100 as determined by standard ISO 5267-1; and

b) subjecting the HRC suspension to fractionation to obtain a fines-depleted highly refined cellulose pulp (FD-HRC) suspension;

wherein said FD-HRC has a Schopper-Riegler (SR) number in the range of 60-100 as determined by standard ISO 5267-1.

In some embodiments, the FD-HRC has an amount of long (>0.2 mm) fibers of at least 8 million fibers per gram (based on dry weight), and

a Fines A value below 46%, wherein the Fines A value is determined using an FS5 optical fiber analyzer.

The HRC and FD-HRC of the second aspect may be further defined as described above with reference to the first aspect.

In some embodiments, the HRC of the HRC suspension, i.e. the starting material, is a microfibrillated cellulose (MFC).

In some embodiments, the HRC suspension comprises at least 50 wt %, preferably at least 70 wt %, more preferably at least 90 wt %, of the FD-HRC based on dry weight of the suspension.

In some embodiments, the HRC suspension further comprises 0.01-10 wt % of a dispersing agent.

The starting material of the inventive method is a highly refined cellulose pulp suspension. Refining, or beating, of cellulose pulps refers to mechanical treatment and modification of the cellulose fibers in order to provide them with desired properties. The highly refined cellulose pulp suspension is an aqueous suspension comprising a water-suspended mixture of cellulose based fibrous material and optionally non-fibrous additives. The pulp suspension can be produced from different raw materials, for example selected from the group consisting of bleached or unbleached softwood pulp or hardwood pulp, Kraft pulp, pressurized groundwood pulp (PGW), thermomechanical (TMP), chemi-thermomechanical pulp (CTMP), neutral sulfite semi chemical pulp (NSSC), or a mixture thereof. It can also be made from broke or recycled paper.

In some embodiments, the HRC is obtained from a chemical pulp.

The HRC may be obtained from a dried or never dried pulp. In some embodiments, the HRC is obtained from a chemical pulp which has been dried. In some embodiments, the HRC is obtained from a never dried chemical pulp.

The term highly refined cellulose pulp as used herein refers to a cellulose pulp having a Schopper-Riegler (SR) number in the range of 60-100 determined by standard ISO 5267-1. In some embodiments, the HRC has a Schopper-Riegler (SR) number in the range of 85-98, preferably in the range of 90-97, as determined by standard ISO 5267-1.

In some embodiments, the HRC of the HRC suspension has an amount of long (>0.2 mm) fibers of at least 10 million fibers per gram (based on dry weight), preferably at least 12 million fibers per gram (based on dry weight), and more preferably at least 14 million fibers per gram (based on dry weight).

In some embodiments, the HRC of the HRC suspension has a Fiber length Lc(n) FS5 ISO in the range of 0.25-0.7 mm, preferably in the range of 0.3-0.6 mm and more preferably in the range of 0.4-0.6 mm.

Any suitable fractionation method known in the art may be used for the fractionation of the HRC to remove some of the fines. Examples of fractionation methods include, but are not limited to, flotation, settling, decanting, belt filtration, wire filtration, sieving, membrane filtration, centrifugation (e.g. using hydrocyclones) and pressure screening.

Many existing pulp fractionation methods are optimized for fractionation of normal pulp suspensions into coarse and fine fractions. In the present disclosure, wherein the starting material is a highly refined cellulose pulp or even a microfibrillated cellulose, the fractionation involves removal, or partial removal, of the finest fraction of cellulose fines. The fractionation may further lead to removal of fine particles of non-cellulosic materials, e.g. inorganic materials, as well as dissolved materials.

Hydrocyclones fractionate solids based on surface area. Experimental studies have shown that hydrocyclones separate fibers according to the specific surface area, specific volume and cell wall thickness. A problem with hydrocyclones is that they are less efficient at higher solids content, such as >0.9 wt %, due to flocculation.

Pressure screens fractionate solids based on size and flexibility. Particle acceptance is determined by fiber flexibility, length, and thickness in that order. Fibers of equal length are accepted by flexibility. Chemical fibers are more readily accepted than stiff mechanical fibers. Fibers of different length are accepted by length, and shorter fibers are accepted more readily than long fibers. In screening, lower solids makes it possible to use finer slits but this requires larger machinery and is thus less economically attractive.

In some embodiments, the fractionation is performed using a RotoWash (Andritz) In the RotoWash the pulp suspension flows over a finely perforated plate with an open area of up to 18%. The the RotoWash uses a combination of a basket and parabolic rotor create optimum flow conditions. Foils on the rotor induce a strong pressure pulse and effect excellent fractionation of the pulp.

In a preferred embodiment, the fractionation is performed using a high-speed belt filter, also known as a belt filter press, normally used in washing conventional pulp suspensions for papermaking, particularly for recycled paper grades such as newspaper and magazine paper containing high amount of fillers and pigments.

A high-speed belt filter is a machine designed for treating pulps to increase consistency by removing water. The pulp and paper making industry has for many years made regular use of such machines for washing and thickening pulp and paper stock, usually for storage or other temporary treatment purposes.

Although high-speed belt filters have been used for washing and thickening conventional pulps used in papermaking, they have not previously been used for fractionation of highly refined cellulose pulps in accordance with the present invention.

Exemplary belt filters include Double Wire Press (available from Andritz-Ahlstrom); BDP (available from Baker Process); Turbodrain (1 wire), Winkelpress (2 wires), and Cascade S (both types in series) (available from Bellmer and Corner); HC Press, Gap Washer, and TwinWire (with Paraformer headbox) (available from Metso Paper/Fiber and Phoenix Process Equipment); Salter Belt Press (available from Salter); DNT Washer (available from Thermo Black Clawson); VarioSplit (available from Voith Paper); and Osprey (available from William Jones, London).

One preferred design for use in the inventive method is the VarioSplit type apparatus. German OS 30 05 681 and the publication “VarioSplit, eine neue Maschine zur Verbesserung von AP-Rohstoffen” in “Wochenblatt für Papierfabrikation” volume 21/1981 p. 787-796 describe the VarioSplit, which is suitable for washing aqueous fiber stock suspensions obtained from waste paper and which also can be applied for thickening of such suspensions (OS 30 05 681 column 2, lines 30 to 34, column 2, line 68 to column 3, line 41). A typical stock suspension to be treated is stated to have a consistency of less than 1.5%, preferably 0.4 to 0.8% (column 3, lines 61 to 67).

The “VarioSplit” apparatus comprises, according to a preferred embodiment, an endless wire or filter band having an outer surface which co-operates with a substantial portion of the surface of a rotatable cylinder, a flat jet nozzle forming a flat suspension jet which is introduced into a substantially wedge-shaped intermediate space between the outer surface of the wire band and the cylinder, a take-off roll, a catch container for the pressed-out water, means for collecting the thickened pulp and three guide rolls (column 2, last line to column 3, line 41 and the single figure). For washing a stock suspension the apparatus is operated in such a way that the fiber web formed between the outer surface of the wire band and the cylinder has a weight of less than 100 g/m², preferably 30 to 70 g/m², and the wire speed and the circumferential speed of the cylinder is in the order of 400 to 1200 m/min (claim 1 and column 3, last line to column 4, line 8).

The use of a high-speed belt filter in the inventive method allows for efficient high-capacity fractionation of highly refined cellulose pulps. The use of a high-speed belt filter allows for fractionation of highly refined cellulose pulps at a scale and speed sufficient for commercial production.

In some embodiments, the high-speed belt filter comprises a wire belt having an air permeability above 4000 m³/m^{2/}hour at 100 Pa.

In some embodiments, the belt of the high-speed belt filter moves at rate of at least 50 m/min, preferably at least 100 m/min, and more preferably at least 200 m/min.

In some embodiments, the dwell time of the highly refined cellulose pulp on the belt is below 7 seconds, preferably below 5 seconds, more preferably below 3 seconds.

In some embodiments, the high-speed belt filter is a single-wire or twin-wire type belt filter. A single-wire type belt filter drains the water from the pulp suspension through a single wire. A twin-wire type belt filter, sandwiches the pulp between two wires, allowing drainage through both wires.

The HRC suspension for use with the inventive method may preferably have a consistency in the range of 0.1-5 wt %. A consistency in the range of 0.1-2.5 wt % has been found to provide a suitable balance between grammage and efficient drainage of water together with cellulose fines. In some embodiments, the consistency of the HRC suspension provided in step a) is in the range of 0.1-2.5 wt %, preferably in the range of 0.1-1.5 wt %, preferably in the range of 0.1-1 wt %, preferably in the range of 0.2-0.8 wt %, more preferably in the range of 0.2-0.6 wt %.

In some embodiments, the HRC suspension is subjected to dilution before being subjected to the fractionation. When diluting the HRC suspension it is important that the liquid used for the dilution, preferably water or an aqueous solution, does not add additional fines to the suspension to any significant extent as this would counteract the purpose of the fractionation. Accordingly, the liquid used for the dilution should preferably be a pure liquid, or at least have a low total solid content. In some embodiments, the liquid used for dilution has a total solid content below 1 wt %, preferably below 0.5 wt %, and more preferably below 0.1 wt %. In some embodiments, the liquid used for dilution has a temperature in the range of 30-90° C., preferably in the range of 35-75° C. In some embodiments, the liquid used for dilution has a pH in the range of 4-10, preferably in the range of 5-9.

In some embodiments, the total solid content of the HRC suspension is reduced by 0.2-4 wt %, preferably by 1-3 wt %, and more preferably by 1.5-2.5 wt %, by the fractionation.

Due to the removal of fine material during the fractionation, it is expected that the FD-HRC will exhibit lower water retention than the HRC. However, it was surprisingly found that the Schopper-Riegler (SR) number of the FD-HRC remained in the same range as the Schopper-Riegler (SR) number of the HRC. In some embodiments, the FD-HRC has a Schopper-Riegler (SR) number in the range of 60-100 determined by standard ISO 5267-1. In some embodiments, the FD-HRC has a Schopper-Riegler (SR) number in the range of 85-98, preferably in the range of 90-97, as determined by standard ISO 5267-1.

In some embodiments, the FD-HRC has a lower water retention value (WRV) than the HRC provided in step a).

The FD-HRC preferably has a relatively high amount of long fibers, i.e. of fibers having a length>0.2 mm. In some embodiments, the FD-HRC has an amount of long (>0.2 mm) fibers of at least 8 million fibers per gram (based on dry weight). In some embodiments, the FD-HRC has an amount of long (>0.2 mm) fibers of at least 10 million fibers per gram (based on dry weight), preferably at least 12 million fibers per gram (based on dry weight), and more preferably at least 14 million fibers per gram (based on dry weight).

In some embodiments, the FD-HRC has a Fiber length Lc(n) FS5 ISO in the range of 0.25-0.7 mm, preferably in the range of 0.3-0.6 mm and more preferably in the range of 0.4-0.6 mm.

The fractionation leads to a reduction of the Fines A and/or Fines B values of the HRC. In some embodiments, the Fines A value of the FD-HRC is at least 3 percentage point(s) lower, preferably at least 5 percentage point(s) lower, and more preferably at least 7 percentage point(s) lower, than the Fines A value of the HRC. In some embodiments, the Fines B value of the FD-HRC is at least 3 percentage point(s) lower, preferably at least 5 percentage point(s) lower, and more preferably at least 7 percentage point(s) lower, than the Fines B value of the HRC.

It has further been found that the fractionation leads to a greater reduction of the Fines A value than of the Fines B value. In some embodiments, the FD-HRC has a Fines A value at least 1 percentage point(s) lower, preferably at least 2 percentage point(s) lower and more preferably in the range of 2-15 percentage point(s) lower, than the Fines B value, wherein the Fines A value and Fines B value are determined using an FS5 optical fiber analyzer.

In some embodiments, the FD-HRC has a Fines A value below 46%, preferably below 43%, and more preferably below 40%.

In some embodiments, the FD-HRC is subjected to gentle shearing or refining after the fractionation in order to re-activate the dewatered and fractionated pulp. In some embodiments, the FD-HRC is subjected to gentle shearing or refining at 5-75 kWh/t, preferably 5-40 kWh/t. Without wishing to be bound to any specific theories, it is also believed that this mechanical re-activation stabilizes the refined fiber and pulp and prevents agglomeration and wet hornification.

The inventive strength enhancement agent may preferably be used as strength enhancing additive in a cellulose pulp (e.g. CTMP) to enhance the strength of paper or paperboard manufactured from the pulp. The strength enhancement agent is typically added to the pulp to be reinforced at a concentration of at least 0.1 wt %, preferably at least 1 wt %, based on dry pulp weight. In some embodiments the strength enhancement agent is added to the pulp to be reinforced at a concentration in the range of 1-25 wt %, preferably in the range of 1-15 wt %, more preferably in the range of 1-10 wt %, most preferably in the range of 2-7 wt %, based on dry pulp weight. In some embodiments the strength enhancement agent is added to the pulp to be reinforced at a concentration in the range of 2-5 wt %, based on dry pulp weight.

When used in a pulp for manufacturing paper or paperboard, the inventive strength enhancement agent may also be combined with one or more additional strength enhancement agents. The additional strength enhancement agents may for example include polysaccharides. In some embodiments the additional strength enhancement agent is starch. In some embodiments, the inventive strength enhancement agent is the main strength enhancement agent based on dry weight. In some embodiments, the starch is the main strength enhancement agent based on dry weight. The inventive strength enhancement agent may for example constitute 1-50 wt % of the total weight of strength enhancement agents in the pulp.

According to a third aspect illustrated herein, there is provided a cellulose pulp for manufacturing paper or paperboard, comprising at least 0.1 wt %, preferably in the range of 1-25 wt %, more preferably in the range of 1-10 wt %, most preferably in the range of 2-7 wt %, of a strength enhancement agent according to the first aspect or obtained by a method according to the second aspect, based on dry pulp weight.

The paper or paperboard may for example be selected from the group consisting of testliner, kraft liner, fluting, graphical paper, label paper, greaseproof paper, high density paper, compact paper, glassine paper, wood free paper, folding boxboard, solid bleached board, solid unbleached board, tissues, white lined chip board, liquid packaging board, white top liner, and sack paper.

In some embodiments, the cellulose pulp is a chemi-thermomechanical pulp (CTMP). In some embodiments, the cellulose pulp comprises recycled pulp or fibers, such as broke or pre or post consumer reject or recycled material.

Paper and paperboard comprising the inventive strength enhancement agent exhibits significantly improved tensile strength and a better Z-strength as compared to corresponding paper and paperboard without the inventive strength enhancement agent.

According to a fourth aspect illustrated herein, there is provided a paper or paperboard comprised of one or more plies, wherein at least one ply comprises at least 0.1 wt %, preferably in the range of 1-25 wt %, more preferably in the range of 1-10 wt %, most preferably in the range of 2-7 wt %, of a strength enhancement agent according to the first aspect or obtained by a method according to the second aspect, based on dry weight. The at least one ply comprising the strength enhancement agent may be a mid-ply or an outer ply of the paper or paperboard.

The strength enhancement agent is particularly useful for improving the strength, e.g. Z-strength and/or tensile strength, of a mid-ply or, bulk ply, of a multiply paper or paperboard. In a preferred embodiment the paper or paperboard is comprised of three or more plies, wherein at least a mid-ply comprises at least 0.1 wt %, preferably in the range of 1-25 wt %, more preferably in the range of 1-10 wt %, most preferably in the range of 2-7 wt %, of a strength enhancement agent according to the first aspect or obtained by a method according to the second aspect, based on dry weight.

Paper generally refers to a material manufactured in thin sheets from the pulp of wood or other fibrous substances comprising cellulose fibers, used for writing, drawing, or printing on, or as packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements.

According to a fifth aspect illustrated herein, there is provided the use of a strength enhancement agent according to the first aspect or obtained by a method according to the second aspect for improving the Z-strength and/or tensile strength of a paper or paperboard. In a preferred embodiment the paper or paperboard is comprised of three or more plies, wherein the strength enhancement agent is used for improving the Z-strength and/or tensile strength of at least a mid-ply.

The strength enhancement agent in the third, fourth and fifth aspects may be further defined as set out above with reference to the first and second aspect.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

### Example 1

### CTMP Sheet (Comparative)

CTMP sheets were prepared with no strength enhancing agent. CTMP was disintegrated according to SCAN M10:77. The sheets were made with a Formette Dynamique Sheet Former, with a CTMP grammage of 100 g/m². A retention system comprising of C-PAM and silica was used.

The drainage resistance was measured according to SCAN C19:65, thickness and density were measured according to ISO 534:2011, the tensile properties were determined according to ISO 1924-3:2005, and the Z strength was measured according to ISO 15754:2009.

### Example 2

### CTMP Sheet With Fibrillated Pulp (Comparative)

A highly fibrillated bleached kraft pulp (FP) was prepared by low consistency fibrillation of bleached softwood kraft pulp to a drainage resistance of ° SR 95.5. Fines A and Fines B values of the highly fibrillated bleached kraft pulp were determined with Valmet FS5 Fiber Image Analyzer to be 47 and 47, respectively.

Dewatering time of the pulp was measured according to the following method. MFC suspension was diluted to 0.1 wt % consistency with reverse osmosis purified water and subjected to rod mixing (30 s) and magnetic stirring (2 min). 125.6 g of the diluted and mixed suspension was poured into the funnel of a vacuum filtration device equipped with a membrane filter (Durapore®, 0.65 μm pore size). The diameter of the round filtration area was 73 mm. Immediately after pouring the suspension into the funnel, vacuum was switched on and time recording started. The dewatering time(s) recorded during the filtration was the time that was needed for all the visible water to disappear from top of the filtration cake. The wet filtration cake was removed from the filtration device together with the membrane filter and placed in between two blotting papers. The filtration cake (i.e. film) was then couched, subjected to wet pressing at 410 kPa for 5 minutes and dried in a drum dryer at 80° C. for at least 90 minutes. The dried film was weighed after conditioning in 23° C./50% RH. To obtain a specific dewatering value (s/g), the recorded dewatering time(s) was divided by the weight of the dried film (g). Four duplicates were done for each sample.

CTMP sheets were prepared as in Example 1, but with 5 wt % FP as strength enhancing agent.

### Example 3

### CTMP Sheet With Fibrillated Pulp With Fines Removed

A part of the highly fibrillated bleached kraft pulp (FP) was then diluted with clean water (substantially free from organic material and other chemicals) and subjected to a fractionation process on the wire of a high-speed belt filter, in whereby a portion of the fines was removed from the fibrillated pulp. The permeability of the wire was 5700 m³/m^{2/}hour at 100 Pa. The fractionated pulp was subjected to a post refining of 20 kWh/t. The resulting fines-depleted highly fibrillated bleached kraft pulp is referred to as “FP+FR”.

After fractionation, the Fines A and Fines B values were reduced to 36 and 38%, respectively. The SR value remained on high level despite (SR=95) even after the fractionation. Dewatering time of the pulp was measured as in Example 2.

CTMP sheets were prepared as in Example 1, but with FP+FR as strength enhancing agent. The addition was 5%.

The dewatering resistance was measured, and it was slightly lower than that of the furnish containing FP.

### Example 4

CTMP sheet With Fibrillated Pulp With Fines Removed. Post Addition of Dispersing Agent to Fibrillated Pulp

A fines-depleted highly fibrillated bleached kraft pulp was prepared as in Example 2. 1.0 kg/t of a dispersing agent (anionic polyacrylamide, Fennopol A8842) was added during a post-refining of 20 kWh/t. The resulting highly fibrillated bleached kraft pulp with dispersing agent is referred to as “FP+FR+dispersing agent”. Dewatering time of the pulp was measured as in Example 2.

CTMP sheets were prepared as in Example 1, but with FP+FR+dispersing agent as a strength enhancing agent. The addition was 5%.

TABLE I
Fibrillated pulp properties

| | Unit | Ex. 2 | Ex. 3 | Ex. 4 |
|---|---|---|---|---|
| FP | % | 100 | | |
| FP + FR | % | | 100 | |
| FP + FR + dispersing agent | % | | | 100 |
| Drainage resistance | °SR | 95.5 | 95.0 | |
| pH | | 7.2 | 6.6 | |
| Amount of fibers >0.2 mm | Million | 19.8 | 17.2 | 17.9 |
| | fibers/g | | | |
| Fiber Length Lc(n) FS5 ISO | mm | 0.46 | 0.49 | |
| Fiber Length Lc(l) FS5 ISO | mm | 0.71 | 0.75 | |
| Fiber curl FS5 | % | 12.7 | 10.6 | |
| Fines A FS5 | % | 47 | 36 | |
| Fines B FS5 | % | 47 | 38 | |
| Dewatering time | s/g | 962 | 779 | 730 |

TABLE II
Furnish compositions

| Fiber composition | Unit | Ex. 1 | Ex. 2 | Ex. 3 | Ex. 4 |
|---|---|---|---|---|---|
| CTMP | % | 100 | 100 | 100 | 100 |
| FP | % | | 5 | | |
| FP + FR | % | | | 5 | |
| FP + FR + dispersing agent | % | | | | 5 |

TABLE III
Furnish properties

| | Unit | Ex. 1 | Ex. 2 | Ex. 3 | Ex. 4 |
|---|---|---|---|---|---|
| Drainage resistance (tap water) | °SR | 18.3 | 23.9 | 23.4 | 23.2 |
| Water retention value | g/g | 1.06 | 1.20 | 1.21 | 1.16 |

TABLE IV
Sheet properties

| | Unit | Ex. 1 | Ex. 2 | Ex. 3 | Ex. 4 |
|---|---|---|---|---|---|
| Grammage | g/m² | 98.2 | 106.6 | 107.1 | 106.3 |
| Thickness single sheet | μm | 293 | 291 | 278 | 280 |
| Density single sheet | kg/m³ | 335 | 367 | 385 | 379 |
| Tensile index MD | Nm/g | 39.3 | 58.8 | 58.9 | 59.9 |
| Tensile index CD | Nm/g | 14.6 | 23.2 | 24.2 | 22.9 |
| Tensile index GM | Nm/g | 24.0 | 36.9 | 37.7 | 37.1 |
| Tensile stiffness index | kNm/g | 5.53 | 6.68 | 6.67 | 6.79 |
| MD | | | | | |
| Tensile stiffness index | kNm/g | 1.61 | 2.29 | 2.39 | 2.27 |
| CD | | | | | |
| Tensile stiffness index | kNm/g | 2.98 | 3.91 | 3.99 | 3.93 |
| GM | | | | | |
| Stretch at break MD | % | 1.31 | 1.84 | 1.87 | 1.87 |
| Stretch at break CD | % | 1.78 | 2.35 | 2.43 | 2.33 |
| Stretch at break GM | % | 1.52 | 2.08 | 2.13 | 2.08 |
| Tensile energy abs. index | J/g | 0.34 | 0.73 | 0.74 | 0.76 |
| MD | | | | | |
| Tensile energy abs. index | J/g | 0.17 | 0.38 | 0.41 | 0.37 |
| CD | | | | | |
| Tensile energy abs. index | J/g | 0.24 | 0.52 | 0.55 | 0.53 |
| GM | | | | | |
| Z-strength | kPa | 129 | 230 | 234 | 231 |

Table IV shows some of the basic sheet properties for the samples without and with fibrillated pulp. Tensile index GM increases with 5 wt % FP addition, but increases surprisingly slightly more for the fractionated fibrillated pulp. Although the difference is small, it is confirming that tensile strength can be maintained or improved despite that the finest fraction was removed. A similar improvement was seen when determining the tensile stiffness index GM, stretch at break GM, tensile energy absorption index GM. Also, a great increase in Z-strength was seen for the samples, and basically remaining on the same level although the fines fraction was removed.

Unless stated otherwise, parameters of the furnishes and sheets were measured according to the following standards:

| | |
|---|---|
| Drainage resistance (tap water) | SCAN C19: 65 |
| Thickness single sheet | ISO 534: 2011 |
| Density single sheet | ISO 534: 2011 |
| Tensile strength (index) | ISO 1924-3: 2005 |
| Tensile stiffness (index) | ISO 1924-3: 2005 |
| Stretch at break | ISO 1924-3: 2005 |
| Tensile energy absorption index | ISO 1924-3: 2005 |
| Z-strength | ISO 15754: 2009 |

The amount of fibers having a length>0.2 mm was determined using the Fiber Tester Plus instrument (L&W/ABB). A known sample weight of 0.100 g is used for each sample and the amount of fibers having a length>0.2 mm (million fibers per gram) is calculated using the following formula: Million fibers per gram=(No. fibers in sample)/(Sample weight)/1 000 000=(Property ID 3141)/property ID 3136)/1 000 000.

Fiber Length Lc(n) ISO, Fiber Length Lc(I) ISO, Fiber curl, Fines A, and Fines B were determined using an FS5 optical fiber analyzer. “Fines A” refers to flake-like fines with a size under 0.2 mm (length<0.2 mm and width<0.2 mm). The projection area of the flake-like fines divided by the total fiber projection area*100%=Fines A. “Fines B” refers to lamella-or fibril like long fines having a width of less than 5 μm and a length over 0.2 mm. The length of these objects divided by the length of all objects with length >0.2 mm*100%=Fines B.

1. A strength enhancement agent for paper and paperboard, said strength enhancement agent comprising:
a fines-depleted highly refined cellulose pulp (FD-HRC),
wherein said FD-HRC has a Schopper-Riegler (SR) number in the a range of 60-100 as determined by standard ISO 5267-1, and
wherein said FD-HRC has an amount of long (>0.2 mm) fibers of at least 8 million fibers per gram (based on a dry weight of the FD-HRC), and
wherein said FD-HRC has a Fines A value below 46%, wherein the Fines A value is determined using an FS5 optical fiber analyzer.

2. The strength enhancement agent according to claim 1, wherein said strength enhancement agent comprises at least 50 wt %.

3. (canceled)

4. The strength enhancement agent according to claim 1, wherein said FD-HRC has a Schopper-Riegler (SR) number in a range of 85-98, as determined by standard ISO 5267-1.

5. The strength enhancement agent according to claim 1, wherein said amount of long (>0.2 mm) fibers is at least 10 million fibers per gram (based on the dry weight of the FD-HRC).

6. The strength enhancement agent according to claim 1, wherein said FD-HRC has a Fiber length Lc (n) FS5 ISO in a range of 0.25-0.7 mm.

7. The strength enhancement agent according to claim 1, wherein said FD-HRC has a Fines A value at least 1 percentage point lower, than a Fines B value, wherein the Fines A value and Fines B value are determined using an FS5 optical fiber analyzer.

8. The strength enhancement agent according to claim 1, wherein said FD-HRC has a Fines A value below 45%.

9. (canceled)

10. (canceled)

11. A method for manufacturing a strength enhancement agent, said method comprising:
a) providing a highly refined cellulose pulp (HRC) suspension comprising HRC, wherein said HRC has a Schopper-Riegler (SR) number in a range of 60-100 as determined by standard ISO 5267-1; and
b) subjecting the HRC suspension to fractionation to obtain a fines-depleted highly refined cellulose pulp (FD-HRC) suspension;
wherein said FD-HRC has a Schopper-Riegler (SR) number in a range of 60-100 as determined by standard ISO 5267-1, and
wherein said FD-HRC has an amount of long (>0.2 mm) fibers of at least 8 million fibers per gram (based on a dry weight of the FD-HRC), and
wherein said FD-HRC has a Fines A value below 46%, wherein the Fines A value is determined using an FS5 optical fiber analyzer.

12. The method according to claim 11, wherein said HRC comprises a microfibrillated cellulose (MFC).

13. The method according to claim 11-12, wherein said HRC suspension comprises at least 50 wt % of the FD-HRC based on a dry weight of the HRC suspension.

14. (canceled)

15. (canceled)

16. (canceled)

17. The method according to claim 11, wherein said HRC has an amount of long (>0.2 mm) fibers of at least 10 million fibers per gram (based on a dry weight of the HRC).

18. The method according to claim 11, wherein said HRC has a Fiber length Lc(n) FS5 ISO in a range of 0.25-0.7 mm.

19. The method according to claim 11, wherein the HRC suspension is subjected to dilution before being subjected to the fractionation, wherein a liquid used for dilution has a total solid content below 1 wt %.

20. The method according to claim 11, wherein a total solid content of the HRC suspension is reduced by 0.2-4 wt % by the fractionation.

21. The method according to any claim 11, wherein said FD-HRC has a Schopper-Riegler (SR) number in a range of 85-98, as determined by standard ISO 5267-1.

22. The method according to claim 11, wherein said amount of long (>0.2 mm) fibers is at least 10 million fibers per gram (based on the dry weight).

23. The method according to claim 11, wherein said FD-HRC has a Fiber length Lc(n) FS5 ISO in a range of 0.25-0.7 mm.

24. The method according to claim 11, wherein said FD-HRC has a Fines A value at least 1 percentage point lower than a Fines B value, wherein the Fines A value and Fines B value are determined using an FS5 optical fiber analyzer.

25. The method according to claim 11, wherein said FD-HRC has a Fines A value below 45%.

26. A cellulose pulp for manufacturing paper or paperboard, comprising:
at least 0.1% by weight, the strength enhancement agent according to claim 1, based on a dry weight.

27. The cellulose pulp according to claim 26, wherein the cellulose pulp is a chemi-thermomechanical pulp (CTMP).

28. A paper or paperboard comprising:
one or more plies, wherein at least one ply comprises at least 0.1% by weight of the strength enhancement agent according to claim 1, based on a dry weight.

29. (canceled)
